(19) United States
(12) Patent Application Publication
(10) Pub. No.: US 2022/0177108 A1
(43) Pub. Date: Jun. 9, 2022

(54) Dynamic Threshold for a Pressure or Altitude Trigger for a Lighter Than Air Vehicle

(71) Applicant: LOON LLC, Mountain View, CA (US)

(72) Inventors: Ewout van Bekkum, Sunnyvale, CA (US); Matt Stokes, San Francisco, CA (US)

(73) Assignee: LOON LLC, Mountain View, CA (US)

(21) Appl. No.: 17/116,961

(22) Filed: Dec. 9, 2020

(51) Int. Cl. B64B 1/62; B64D 17/78

(52) U.S. Cl. CPC B64B 1/62; B64D 17/78

(57) ABSTRACT

The technology relates to techniques for a dynamic threshold for a pressure or altitude trigger for a lighter than air vehicle. A method of operating a system of an LTA vehicle can include setting a dynamic threshold of a system to a first value based on one or both of a first measured pressure altitude and a first measured absolute pressure, receiving an indication that the LTA vehicle has increased its altitude, and setting the dynamic threshold of the system to a second value based on one or both of a second measured pressure altitude and a second measured absolute pressure. A flight termination system for an LTA vehicle can include mechanical actuation systems configured to be triggered based on dynamic thresholds. A method of terminating the flight of an LTA vehicle can include triggering the mechanical actuation systems based on dynamic thresholds.

### BACKGROUND OF INVENTION

Fleets of lighter than air (LTA) aerial vehicles are being considered for a variety of purposes, including providing data and network connectivity, data gathering (e.g., image capture, weather and other environmental data, telemetry), and systems testing, among others. LTA vehicles can utilize a balloon envelope, a rigid hull, or a non-rigid hull filled with a gas mixture that is lighter than air to provide lift. In other words, the gas that is lighter than air within the envelope displaces the heavier air, thereby providing buoyancy to the LTA vehicle. Some LTA vehicles are propelled in a direction of flight using propellers driven by engines or motors and utilize fins to stabilize the LTA vehicle in flight.

LTA vehicles can employ flight termination systems that terminate the flight of the vehicle. For example, at the end of a planned flight the LTA vehicle may need to be brought back down to the ground for retrieval, the LTA vehicle may need maintenance, or components of the LTA vehicle may need servicing. In some cases, a flight termination system can be used to bring the LTA vehicle back down to the ground due to an unplanned event, such as if the LTA vehicle has drifted outside of a predetermined geographical area, or if a GPS or a processor onboard the LTA vehicle fails.

### BRIEF SUMMARY

The present disclosure provides techniques for a dynamic threshold for a pressure or altitude trigger for a lighter than air vehicle. A flight termination system (FTS) for a lighter than air (LTA) vehicle can include: a first mechanical actuation system configured to be triggered in a first stage based on a first dynamic threshold, the first mechanical actuation system further configured to cause an envelope and a payload of the LTA vehicle to separate; and a second mechanical actuation system configured to be triggered in a second stage based on a second dynamic threshold, the second mechanical actuation system further configured to cause a parachute to deploy from a component coupled to the payload, wherein the first and second dynamic thresholds change, and wherein the FTS is configured to trigger the first mechanical actuation system before triggering the second mechanical actuation system. In an example, the first and second mechanical actuation systems each comprise a squib. In another example, the first dynamic threshold and the second dynamic threshold are each a pressure altitude threshold that is updated during an initial ascent of the LTA vehicle based on a measured pressure altitude minus a predetermined offset. In another example, the first dynamic threshold and the second dynamic threshold are each an absolute pressure threshold that is updated during an initial ascent of the LTA vehicle based on a sum of a measured absolute pressure and a predetermined offset.

A method of terminating the flight of a lighter than air (LTA) vehicle can include: triggering a first mechanical actuation system of a flight termination system (FTS) based on a first dynamic threshold, thereby causing the first mechanical actuation system to fire, in response to which an envelope and a payload of the LTA vehicle is separated; and triggering a second triggered mechanical actuation system of the FTS based on a second dynamic threshold and after triggering the first triggered mechanical actuation system, thereby causing the second triggered mechanical actuation system to fire, in response to which a parachute is deployed from the payload, wherein the first and second dynamic thresholds change. In an example, the first and second mechanical actuation systems each comprise a squib. In another example, each of the first dynamic threshold and the second dynamic threshold is a pressure altitude threshold that is updated during an initial ascent of the lighter than air vehicle based on a measured pressure altitude minus a predetermined offset. In another example, the above predetermined offset is constant. In another example, the above predetermined offset is variable and is determined using a function or a lookup table. In another example, each of the first dynamic threshold and the second dynamic threshold is an absolute pressure threshold that is updated during an initial ascent of the lighter than air vehicle based on a measured absolute pressure plus a predetermined offset. In another example, the above predetermined offset is constant. In another example, the above predetermined offset is variable and is determined using a function or a lookup table. In another example, the above method further includes, before triggering the first mechanical actuation system of the flight termination system, performing the following steps: setting a third dynamic threshold to a first value; receiving an indication that the altitude of the lighter than air vehicle has increased; and setting a fourth dynamic threshold to a second value.

A method of operating a system of a lighter than air (LTA) vehicle can include: setting a dynamic threshold of a system to a first value based on a first predetermined offset and one or both of a first measured pressure altitude and a first measured absolute pressure; receiving an indication that the LTA vehicle has increased its altitude; and setting the dynamic threshold of the system to a second value based on a second predetermined offset and one or both of a second measured pressure altitude and a second measured absolute pressure. In an example, the first and second absolute pressure measurements and the first and second pressure altitude measurements are measured using one or more sensors onboard the LTA vehicle. In another example, the above method further includes, after setting the second dynamic threshold, and after an altitude of the LTA vehicle is above a float altitude floor, changing a mode of the system to operate using a high-altitude failsafe trigger. In another example, the predetermined offset is constant. In another example, the predetermined offset is variable and is determined using a function or a lookup table. In another example, the system is a flight termination system.

### BRIEF DESCRIPTION OF THE DRAWINGS

FIG. 1 is a simplified schematic of an example of an LTA vehicle 100 in side view at four different instants in time, comprising a flight termination system (FTS) with dynamic triggers, in accordance with some embodiments.

FIG. 2 is a simplified schematic of an example of an LTA vehicle 100 in side view at three different instants in time, comprising an FTS with dynamic triggers, in accordance with some embodiments.

FIGS. 3A-3B are diagrams of example LTA vehicle systems incorporating FTSs with dynamic triggers, in accordance with some embodiments.

FIG. 4 is a simplified block diagram of an example of a computing system forming part of the systems of FIGS. 3A-3B, in accordance with one or more embodiments.

FIG. 5 is a flow diagram illustrating a method for operating an FTS in an LTA vehicle, in accordance with one or more embodiments.

FIG. 6 is a flow diagram illustrating a method for terminating the flight of an LTA vehicle, in accordance with one or more embodiments.

The figures depict various example embodiments of the present disclosure for purposes of illustration only. One of ordinary skill in the art will readily recognize from the following discussion that other example embodiments based on alternative structures and methods may be implemented without departing from the principles of this disclosure, and which are encompassed within the scope of this disclosure.

### DETAILED DESCRIPTION

The Figures and the following description describe certain embodiments by way of illustration only. One of ordinary skill in the art will readily recognize from the following description that alternative embodiments of the structures and methods illustrated herein may be employed without departing from the principles described herein. Reference will now be made in detail to several embodiments, examples of which are illustrated in the accompanying figures.

The invention is directed to a dynamic threshold for a pressure or altitude trigger for a lighter than air (LTA) vehicle. LTA vehicles can utilize absolute pressure and/or geopotential pressure altitude measurements to trigger (i.e., fire or otherwise cause an action to occur in) various systems, such as triggering one or more stages of a flight termination system (FTS) when the LTA vehicle descends below a threshold altitude (e.g., at or slightly above or below 10,000 feet, 20,000 feet, or 35,000 feet for a stratospheric balloon, or higher or lower for other types of LTA vehicles) and/or the ambient pressure is greater than a threshold pressure (e.g., 0.6 atm, 0.35 atm, or 0.15 atm). For example, when an LTA vehicle descends below a threshold altitude (or experiences a pressure above a threshold pressure) an FTS can use triggered mechanical actuation (e.g., where the mechanical actuation uses a squib) to sequence an FTS including envelope and vehicle separation, followed by payload parachute deployment (and envelope parachute deployment in some cases). Such FTSs can actuate in a very deterministic, highly reliable and available manner.

In order to prevent the FTS from triggering on the ground and during initial ascent, a set of dynamic thresholds (i.e., thresholds that change) can be used to permit safe ascent to float (i.e., where the LTA vehicle is at a target flight altitude, or within a target flight altitude range, e.g., approximately 50,000 to 65,000 feet, or up to 75,000 feet). An LTA vehicle may have a range of float altitudes, where a float altitude floor can be approximately 45,000 feet, 50,000 feet, or from 45,000 feet to 55,000 feet, and a float altitude ceiling can be approximately 65,000 feet or approximately 75,000 feet, or from approximately 65,000 feet to approximately 75,000 feet. In some cases, the float altitude is lower than 45,000 feet, such as from 20,000 feet to 45,000 feet. In some cases, once the LTA vehicle reaches float (or is within a float altitude range, or is above a float altitude floor) then the LTA vehicle can be configured to transition to high altitude failsafe triggers. In some cases, an LTA vehicle can transition to lower altitude planned triggers at a later time during the LTA vehicle flight, for example to prevent premature actuation of the FTS while the LTA vehicle is intentionally descending to a lower altitude. Additionally, in cases where the LTA vehicle is descending, then the FTS can be prevented from triggering by using a set of dynamic thresholds the same as or similar to those used during ascent.

Other examples of systems that can be triggered based on absolute pressure and/or geopotential pressure altitude measurements and dynamic thresholds are active control systems and propulsion systems (e.g., brakes on a propeller). For example, a motor driving a propeller can be shut down or a brake can be actuated to slow down the propeller in response to absolute pressure and/or geopotential pressure altitude dynamic thresholds being exceeded.

For example, when an LTA vehicle descends below a dynamic threshold altitude (or experiences a pressure above a dynamic threshold pressure) an FTS can use triggered mechanical actuation (e.g., where the mechanical actuation uses a squib) to sequence an FTS including envelope and vehicle separation, followed by payload parachute deployment (and envelope parachute deployment in some cases). Using dynamic thresholds, for example, can be changed during an initial ascent of the LTA vehicle, and enable the FTS to trigger if there is a problem and the LTA vehicle has not yet reached a float altitude. In another example, when an LTA vehicle descends above a dynamic threshold altitude (or experiences a pressure below a dynamic threshold pressure) a system can be triggered. For example, an FTS can trigger a parachute to be deployed from an envelope of an LTA vehicle if the LTA vehicle ascends above a pressure altitude dynamic threshold (or below a dynamic threshold absolute pressure).

The dynamic triggers can be “dynamic ascent absolute pressure” and/or “dynamic ascent pressure altitude” triggers. In the case of absolute pressure or pressure altitude triggers, the dynamic triggers use dynamic thresholds that are updated during an initial ascent (or a descent) of the LTA vehicle. In some cases, the number of times that the dynamic thresholds can be updated (e.g., during an initial ascent of an LTA vehicle) is greater than 5, or greater than 10, or greater than 100, or greater than 1000, or from 5 to 10, or from 5 to 50, or from 5 to 100, or from 5 to 1000. For example, the dynamic thresholds can be updated at regular or irregular intervals of time. In some cases, the dynamic thresholds can be updated as a function of absolute pressure and/or pressure altitude, which may be derived from one or a combination of sensor measurements, estimations (e.g., based on models, machine learning algorithms, historical data), or time thresholds (e.g., from time of launch based on extrapolations and/or calculations using historical or real-time altitude or pressure data). In some cases, a dynamic threshold is updated using a measured pressure and/or altitude, and using a predetermined offset. The predetermined offsets can be constant throughout an ascent or descent, or the predetermined offsets can be variable (i.e., dynamic) and change throughout an ascent or descent. For example, dynamic thresholds for these triggers can be calculated based on the highest effective altitude measured (e.g., by geopotential pressure altitude measurement systems on the LTA vehicle) and a predetermined offset. The predetermined offset can itself be variable, and can be determined using a function (e.g., a function of pressure altitude and/or absolute pressure), a lookup table, or other relationship. In the case of a dynamic ascent absolute pressure trigger, a static pressure offset can be added to a minimum detected pressure as the LTA vehicle ascends. In the case of a dynamic ascent pressure altitude trigger, a static distance offset can be subtracted from the maximum detected pressure altitude as the LTA vehicle ascends. In other cases, the measured absolute pressure or pressure altitude can be transformed by applying a function or using a lookup table to determine the dynamic thresholds. For example, an offset can be applied that is proportional to a measured pressure altitude (e.g., with a particular proportionality constant), such that larger offsets are subtracted from higher measured pressure altitudes to determine the dynamic thresholds. In some cases, the dynamic thresholds in the lookup table that are associated with measured absolute pressures or pressure altitudes are based on an estimated maximum pressure altitude (or an estimated minimum absolute pressure). Other transformations can also be employed. For example, a linear transformation can be used to transform a measured absolute pressure or pressure altitude to a dynamic threshold. More complicated transformations can also be employed, for example, using a lookup table that associates a set of measured absolute pressures or pressure altitudes to a set of dynamic thresholds. For example, a more complex transformation can be used to set dynamic thresholds based on measured absolute pressures or pressure altitudes where different offsets (or safety margins) are applied to the dynamic thresholds in different ranges of measured absolute pressure or pressure altitude. This can help ensure that all of the specified system safety margins can be met throughout the range of operational absolute pressures and pressure altitudes. Alternatively, a constant offset can be used throughout the range of operational absolute pressures and pressure altitudes, where the constant offset is large enough to ensure that all of the specified system safety margins can be met throughout the range of operational absolute pressures and pressure altitudes. In some cases, filtering can be used to reduce the noise of absolute pressure and/or pressure altitude measurements to reduce the chances of a false positive flight terminating actuation during the initial ascent (or during an ascent that is not the initial ascent, a descent).

In some cases, the same static or dynamic offsets used to determine the dynamic thresholds can be used for an LTA vehicle during an initial ascent, an ascent that is not the initial ascent, and a descent. For example, in the case of a dynamic pressure altitude trigger used for descent, a static distance offset can be subtracted from the minimum detected pressure altitude as the LTA vehicle descends. In another example, in the case of a dynamic absolute pressure trigger used for descent, a static pressure offset can be added to a maximum detected pressure as the LTA vehicle descends. In some cases, the dynamic thresholds are determined during an initial ascent, an ascent that is not the initial ascent, or a descent, using different static or dynamic offsets for each situation.

In an example, an FTS can have at least two actuated stages, where a payload is separated from an envelope in a stage, and a parachute is deployed from the payload (or from a component coupled to the payload) in a subsequent stage. The FTS can have additional stages that are triggered or automatic (e.g., automatically initiated at a dynamic pressure threshold), such as drogues and/or an envelope parachute being deployed from the envelope after the payload and envelope are separated. In order to minimize damage to the LTA vehicle (e.g., from the envelope impacting the payload) the FTS can be configured to trigger the FTS stages in sequence with some delay(s) between the stages. For example, during descent the envelope of the LTA vehicle can become deflated and can impact the payload causing damage. To minimize the possibility of such damage, the FTS can be configured to separate the envelope from the payload, wait some amount of time for the payload to descend away from the envelope (since the envelope and the payload will likely have different velocities and terminal velocities during descent), and then deploy a parachute from the payload (or from a component coupled to the payload). The parachute from the payload will slow the rate of descent of the payload and reduce the chance of damage to the payload upon reaching the ground. In some cases, after the envelope and the payload are separated and before a parachute is deployed from the payload, the payload will have a faster rate of descent than the envelope.

To execute such an FTS with two (or more) actuated stages, two (or more) different sets of dynamic thresholds for two (or more) parallel sets of dynamic triggers (i.e., one (or more) triggers for each actuated FTS stage) can be used to ensure that, for example, the payload-envelope separation and payload parachute deployment occurs in the correct sequence with the correct timing delays between the stages. In some cases, the two (or more) sets of dynamic thresholds can be determined using two (or more) sets of predetermined offsets, or other transformations, as described herein. For example, a first dynamic trigger can use a first dynamic threshold determined using a first predetermined offset to actuate a separation of an envelope and a payload of an LTA vehicle, and a second dynamic trigger can use a second dynamic threshold determined using a second predetermined offset to actuate a parachute deployment from the payload (or from a component coupled to the payload), where the second dynamic trigger causes the payload parachute to deploy at an absolute pressure above the absolute pressure (or at a pressure altitude below the pressure altitude) that triggers the first dynamic trigger. In another example, a first dynamic trigger can use a first predetermined offset to actuate a separation of an envelope and a payload of an LTA vehicle, and a second trigger causes the payload parachute to deploy after a predetermined amount of time after the first dynamic trigger is triggered.

Once the vehicle reaches float (or is above the float altitude floor) and/or is sufficiently above the failsafe and/or planned trigger setpoints (with sufficient safety margins), then the system can be reconfigured to stop using the dynamic ascent thresholds (e.g., for the remainder of flight).

The absolute pressure measurements and/or the pressure altitude measurements used to determine the dynamic thresholds can be taken using one or more sensors onboard the LTA vehicle. The absolute pressure and/or pressure altitude sensors can be located within the payload of the LTA vehicle, or coupled to the envelope of the LTA vehicle, or coupled to a down-connect that couples the envelope with the payload.

In some cases, an FTS uses triggered mechanical actuation to actuate different stages. In some cases, one or more FTS stages are actuated using squibs. In some cases, the FTS can trigger a squib to apply force on a mechanical component causing that component to break, thereby actuating a stage of the FTS. For example, a squib can apply a force on bolts or other mechanical components that couple an envelope of an LTA vehicle to a payload of the LTA vehicle, thereby causing the mechanical component to break and the envelope and payload to separate. In another example, the FTS can trigger a squib to deploy a parachute from the payload, or from a component coupled to the payload.

### Example Systems

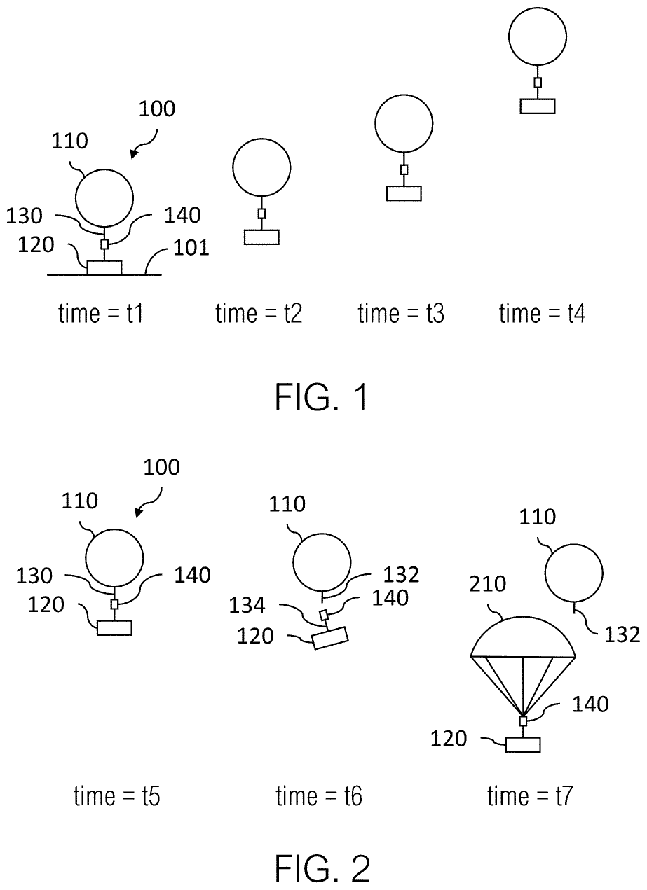

FIG. 1 is a simplified schematic of an example of an LTA vehicle 100 in side view at four different instants in time (t1, t2, t3 and t4), comprising an FTS with dynamic triggers. The LTA vehicle 100 in FIG. 1 contains an envelope 110, a payload 120, and a down-connect 130 coupling the envelope 110 to the payload 120. The LTA vehicle 100 in this example has a down-connect 130 with an additional module 140. The module 140 can, in some examples, be a component of the FTS system containing squib actuated systems for separating the envelope 110 from the payload 120. For example, module 140 can contain mechanical actuation systems that use squibs to separate the envelope 110 and the payload 120. In some examples, module 140 can be an actuation module that provides a means to actively turn payload 120. In some examples, module 140 can be an electronics assembly containing wiring electrically coupling electronics components coupled to the envelope 110 with electronics components coupled to the down-connect 130 and/or the payload 120. The module 140 is shown coupled to the down-connect 130 at a location in this example. However, in other examples, module 140 can be coupled to the down-connect 130 at a different location, such as a location adjacent to the envelope 110, or a location adjacent to the payload 120. In some cases, module 140 can be coupled directly to the envelope 110 or the payload 120, and be a component of the FTS system containing squib actuated systems for separating the envelope 110 from the payload 120.

FIG. 1 shows the LTA vehicle 100 at four instants in time, t1, t2, t3, and t4. At time t1 the LTA vehicle 100 is launched from the ground 101, and then the LTA vehicle 100 begins an initial ascent. At time t2 the LTA vehicle 100 is in its initial ascent and has not yet reached a final float altitude (i.e., is below a float altitude floor). At time t3 the LTA vehicle 100 is at a higher altitude than it was at time t2, but is still in its initial ascent and has not yet reached a final float altitude. At time t4, the LTA vehicle 100 has reached a float altitude. At time t4, the LTA vehicle 100 can use static high-altitude failsafe triggers for an FTS. For example, a float altitude can be approximately 60,000 feet, and the FTS can be configured to trigger the FTS (or a first stage of the FTS) if the pressure altitude of the LTA vehicle 100 is ever measured to be below a static threshold of 35,000 feet.

At times t1, t2 and t3 the LTA vehicle 100 can be below the static pressure altitude threshold of the static high-altitude failsafe triggers of the FTS, and therefore dynamic triggers can be used to prevent the FTS from prematurely actuating during initial ascent. For example, at time t1 the FTS can be configured to use dynamic triggers with dynamic thresholds. At time t2, a first dynamic threshold can be determined using a first measured absolute pressure or pressure altitude and a predetermined (static or dynamic) offset. Between time t2 and t3 the LTA vehicle 100 ascends, and at time t3 a second dynamic threshold can be determined using a second measured absolute pressure or pressure altitude and a predetermined (static or dynamic) offset. At time t4, the FTS can be reconfigured to use static high-altitude failsafe triggers, instead of dynamic triggers.

In some cases, a computer (described further below) is coupled to and controls different components of the FTS. For example, a computer can be used to receive measurements of the absolute pressure or pressure altitude (e.g., by interfacing with sensors), set dynamic thresholds (e.g., by performing calculations, for example, using sensor measurements and offsets, lookup tables, and/or other functions), and trigger components of the FTS (e.g., mechanical actuation systems).

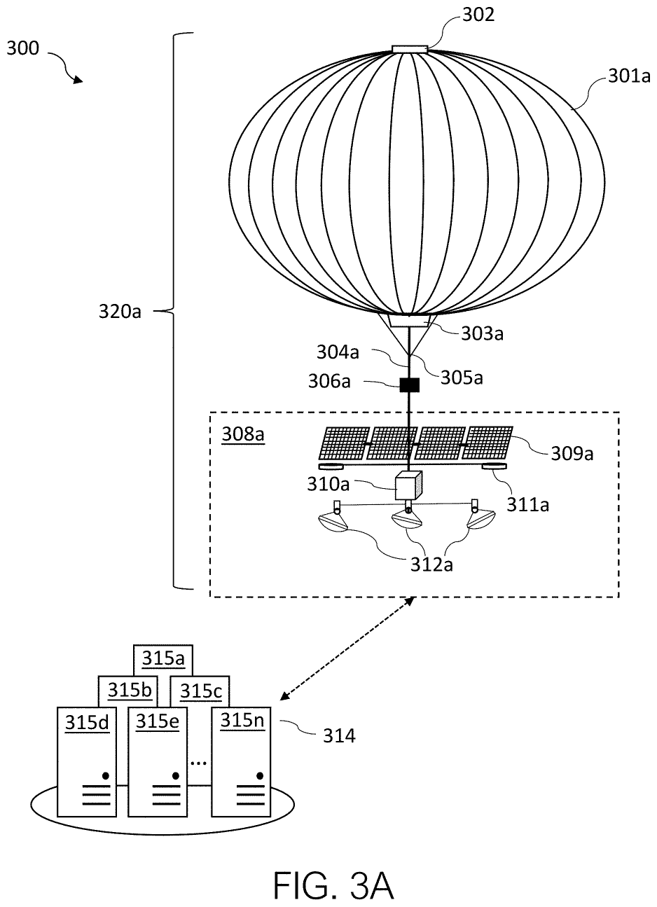

FIG. 2 is a simplified schematic of an example of an LTA vehicle 100 in side view at three different instants in time (t5, t6 and t7), comprising an FTS with dynamic triggers. The LTA vehicle 100 contains envelope 110, payload 120, down-connect 130, and additional module 140, as described herein. Times t5, t6 and t7 are all before time t4 in FIG. 1, and an FTS of the LTA vehicle 100 can, therefore, be configured to use dynamic triggers with dynamic thresholds. At time t5 pressure altitude measured by the LTA vehicle 100 is above a dynamic pressure altitude threshold (or a measured absolute pressure is below a dynamic absolute pressure threshold) and therefore the FTS system does not actuate.

At time t6 the measured pressure altitude of LTA vehicle 100 is below a dynamic pressure altitude threshold (or a measured absolute pressure is above a dynamic absolute pressure threshold) and the FTS has triggered a first stage, wherein the envelope 110 has separated from the payload 120. In this first stage, a mechanical actuation system (e.g., using squibs) is triggered to separate the envelope 110 from the payload 120. In the example shown in FIG. 2, after this FTS stage the down-connect has separated into two pieces 132 and 134, coupled to the envelope 110 and the payload 120, respectively, and module 140 is coupled to the down-connect 134 that is coupled to the payload 120. In other examples, the down-connect 130 can separate at a different location, or not separate at all and remain coupled to either the envelope 110 or the payload 120 after the envelope 110 and the payload 120 separate in a stage of the FTS. In the example shown in FIG. 2, the module 140 is a component of the FTS system (e.g., containing squib actuated mechanical systems) for separating the envelope 110 from the payload 120 at time t6.

Between times t6 and t7 the payload 120 is not connected to the envelope 110 and begins to descend. In some cases, the payload descends at a faster rate than the envelope during this time interval. The FTS then triggers a second stage, where a parachute 210 is deployed from a component (e.g., module 140) coupled to the payload 120. Time t7 shows the parachute 210 after it has been deployed. The parachute slows the rate of descent of the payload 120, thereby reducing the chance of damage upon reaching the ground.

In some cases, before or after times t6 or t7, the FTS in this example can trigger additional stages. For example, after time t6 or after time t7, the FTS can deploy a parachute from the envelope 110. In some cases, the FTS can deploy a parachute from a component (not shown) coupled to the portion of the down-connect 132 coupled to the envelope 110. In some cases, a dynamic pressure can cause the parachute to deploy from envelope 110 after time t6 or after time t7. For example, after time t6 or after time t7, a second parachute (not shown) can be deployed from the portion of the down-connect 132 or from the envelope 110, based on the LTA vehicle ascending above a pressure altitude dynamic threshold (or below a dynamic threshold absolute pressure). In the case of a communication failure (e.g., between different systems within the LTA vehicle and/or between the LTA vehicle and a ground station), a robust way of detecting a separation of the payload 120 from the envelope 110 is detecting that the envelope 110 of the LTA vehicle has exceeded a typical (or predetermined) float altitude (e.g., due to the buoyancy of the envelope 110). Such a separation detection method can be faster than waiting for batteries of an FTS to run out, and can also be more available than relying on SATCOM communication to the FTS on the envelope.

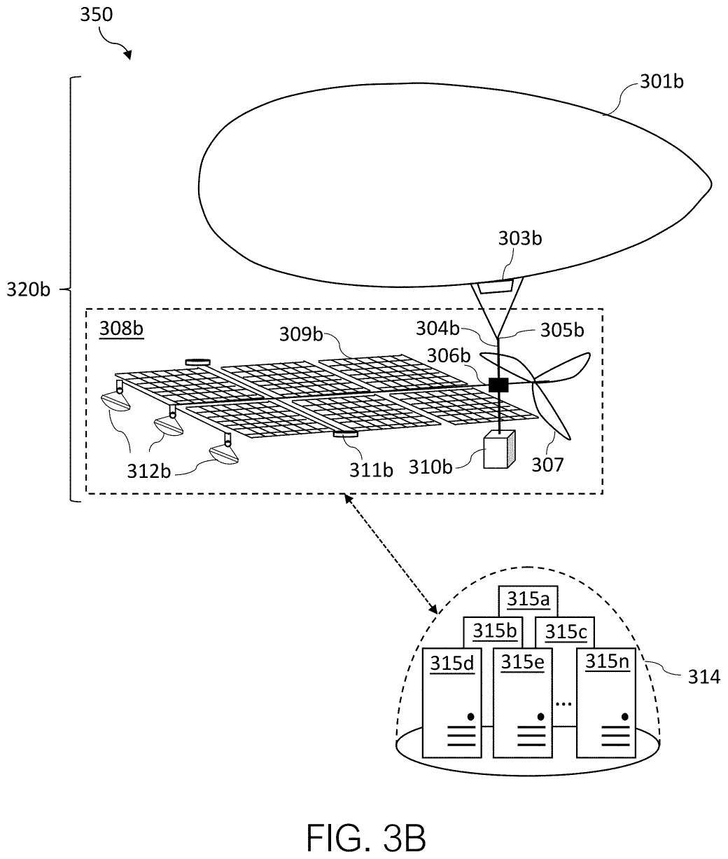

FIGS. 3A-3B are diagrams of example LTA vehicle systems incorporating FTSs with dynamic triggers, in accordance with some embodiments. The LTA vehicles 320a-b shown in FIGS. 3A-3B, and described further below, contain FTSs with stages triggered by dynamic triggers using dynamic thresholds, as described above.

In FIG. 3A, there is shown a diagram of system 300 for navigation of LTA vehicle 320a. In some examples, LTA vehicle 320a may be a passive vehicle, such as a balloon or satellite, wherein most of its directional movement is a result of environmental forces, such as wind and gravity. In other examples, LTA vehicles 320a may be actively propelled. In an embodiment, system 300 may include LTA vehicle 320a and ground station 314. In this embodiment, LTA vehicle 320a may include balloon 301a, plate 302, altitude control system (ACS) 303a, connection 304a, joint 305a, actuation module 306a, and payload 308a. In some examples, plate 302 may provide structural and electrical connections and infrastructure. Plate 302 may be positioned at the apex of balloon 301a and may serve to couple together various parts of balloon 301a. In other examples, plate 302 also may include a flight termination unit (e.g., that is a part of the FTS system), such as one or more blades and an actuator to selectively cut a portion and/or a layer of balloon 301a. ACS 303a may include structural and electrical connections and infrastructure, including components (e.g., fans, valves, actuators, etc.) used to, for example, add and remove air from balloon 301a (i.e., in some examples, balloon 301a may include an interior ballonet within its outer, more rigid shell that is inflated and deflated), causing balloon 301a to ascend or descend, for example, to catch stratospheric winds to move in a desired direction. Balloon 301a may comprise a balloon envelope comprised of lightweight and/or flexible latex or rubber materials (e.g., polyethylene, polyethylene terephthalate, chloroprene), tendons (e.g., attached at one end to plate 302 and at another end to ACS 303a) to provide strength to the balloon structure, a ballonet, along with other structural components. In various embodiments, balloon 301a may be non-rigid, semi-rigid, or rigid.

Connection (i.e., down-connect) 304a may structurally, electrically, and communicatively, connect balloon 301a and/or ACS 303a to various components comprising payload 308a. In some examples, connection 304a may provide two-way communication and electrical connections, and even two-way power connections. Connection 304a may include a joint 305a, configured to allow the portion above joint 305a to pivot about one or more axes (e.g., allowing either balloon 301a or payload 308a to tilt and turn). Actuation module 306a may provide a means to actively turn payload 308a for various purposes, such as improved aerodynamics, facing or tilting solar panel(s) 309a advantageously, directing payload 308a and propulsion units (e.g., propellers 307 in FIG. 3B) for propelled flight, or directing components of payload 308a advantageously. In some cases, the down-connect 304a is configured to separate at a separation point causing the payload 308a and the balloon 301a to separate from one another (e.g., due to triggering by an FTS). In such cases, the down-connect can also include a parachute (not shown) (e.g., similar to parachute 210 in FIG. 2) that can be deployed to slow the descent of the payload 308a after separation. The separation point can be located anywhere on the down-connect 304a. For example, the separation point can be located at a point closer to the balloon 301a than a parachute coupled to the down-connect 304a, such that after separation the parachute remains coupled to the payload 308a. In some cases, a parachute is coupled to the down-connect 304a at a location close to the payload 308a, the separation point is close to the parachute at a location between the parachute and the balloon 301a, and other components (e.g., an actuation component, a propulsion component, and/or a flexible knuckle) are coupled to the down-connect 304a between the separation point and the balloon 301a.

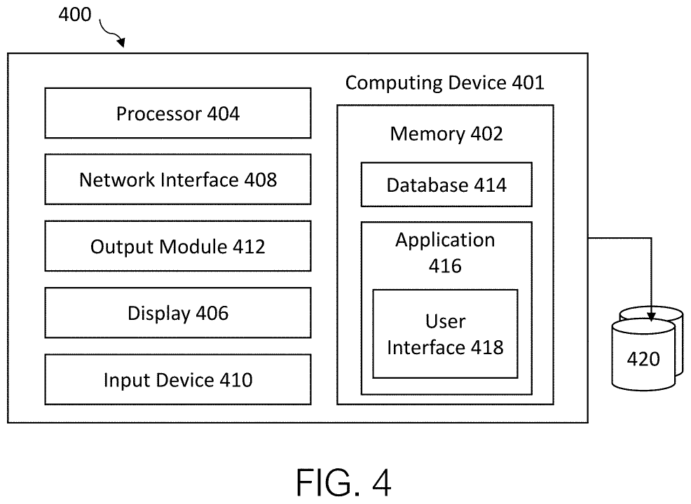

Payload 308a may include solar panel(s) 309a, avionics chassis 310a, broadband communications unit(s) 311a, and terminal(s) 312a. Solar panel(s) 309a may be configured to capture solar energy to be provided to a battery or other energy storage unit, for example, housed within avionics chassis 310a. Avionics chassis 310a also may house a flight computer (e.g., to electronically control various systems within the LTA vehicle 320a, such as computing device 401 in FIG. 4), a transponder, along with other control and communications infrastructure (e.g., a computing device and/or logic circuit configured to control LTA vehicle 320a). In some cases, the flight computer controls the FTS and calculates the dynamic triggers for the FTS. Communications unit(s) 311a may include hardware to provide wireless network access (e.g., LTE, fixed wireless broadband via 5G, Internet of Things (IoT) network, free space optical network or other broadband networks). Terminal(s) 312a may comprise one or more parabolic reflectors (e.g., dishes) coupled to an antenna and a gimbal or pivot mechanism (e.g., including an actuator comprising a motor). Terminal(s) 312(a) may be configured to receive or transmit radio waves to beam data long distances (e.g., using the millimeter wave spectrum or higher frequency radio signals). In some examples, terminal(s) 312a may have very high bandwidth capabilities. Terminal(s) 312a also may be configured to have a large range of pivot motion for precise pointing performance Terminal(s) 312a also may be made of lightweight materials.

In other examples, payload 308a may include fewer or more components, including propellers 307 as shown in FIG. 3B, which may be configured to propel LTA vehicles 320a-b in a given direction. In still other examples, payload 308a may include still other components well known in the art to be beneficial to flight capabilities of an LTA vehicle. For example, payload 308a also may include energy capturing units apart from solar panel(s) 309a (e.g., rotors or other blades (not shown) configured to be spun by wind to generate energy). In another example, payload 308a may further include or be coupled to an imaging device (e.g., a star tracker, IR, video, Lidar, and other imaging devices, for example, to provide image-related state data of a balloon envelope, airship hull, and other parts of an LTA vehicle). In another example, payload 308a also may include various sensors (not shown), for example, housed within avionics chassis 310a or otherwise coupled to connection 304a or balloon 301a. Such sensors may include Global Positioning System (GPS) sensors, wind speed and direction sensors such as wind vanes and anemometers, temperature sensors such as thermometers and resistance temperature detectors, speed of sound sensors, acoustic sensors, pressure sensors such as barometers and differential pressure sensors, accelerometers, gyroscopes, combination sensor devices such as inertial measurement units (IMUs), light detectors, light detection and ranging (LIDAR) units, radar units, cameras, other image sensors, and more. These examples of sensors are not intended to be limiting, and those skilled in the art will appreciate that other sensors or combinations of sensors in addition to these described may be included without departing from the scope of the present disclosure.

Ground station 314 may include one or more server computing devices 315a-n, which in turn may comprise one or more computing devices (e.g., a computing device and/or logic circuit configured to control LTA vehicle 320a). In some examples, ground station 314 also may include one or more storage systems, either housed within server computing devices 315a-n, or separately. Ground station 314 may be a datacenter servicing various nodes of one or more networks.

FIG. 3B shows a diagram of system 350 for navigation of LTA vehicle 320b. All like-numbered elements in FIG. 3B are the same or similar to their corresponding elements in FIG. 3A, as described above (e.g., balloon 301a and balloon 301b may serve the same function, and may operate the same as, or similar to, each other). In some examples, balloon 301b may comprise an airship hull or dirigible balloon. In this embodiment, LTA vehicle 320b further includes, as part of payload 308b, propellers 307, which may be configured to actively propel LTA vehicle 320b in a desired direction, either with or against a wind force to speed up, slow down, or re-direct, LTA vehicle 320b. In this embodiment, balloon 301b also may be shaped differently from balloon 301a, to provide different aerodynamic properties.

As shown in FIGS. 3A-3B, LTA vehicles 320a-b may be largely wind-influenced LTA vehicle, for example, balloons carrying a payload (with or without propulsion capabilities) as shown, or fixed wing high altitude drones (not shown) with gliding and/or full propulsion capabilities. However, those skilled in the art will recognize that the systems disclosed herein may similarly apply and be usable by various other types of LTA vehicles.

FIG. 4 is a simplified block diagram of an example of a computing system forming part of the systems of FIGS. 3A-3B, in accordance with one or more embodiments. Any reference to a computer (e.g., flight computer, server, etc.) herein may be implemented using the computing system 400 in FIG. 4. In some cases, the computing system 400 is coupled to different components of the FTS (e.g., sensors and mechanical actuation systems), controls the FTS, and calculates the dynamic triggers for the FTS. In one embodiment, computing system 400 may include computing device 401 and storage system 420. Storage system 420 may comprise a plurality of repositories and/or other forms of data storage, and it also may be in communication with computing device 401. In another embodiment, storage system 420, which may comprise a plurality of repositories, may be housed in one or more of computing device 401 (not shown). In some examples, storage system 420 may store state data, commands, flight policies, and other various types of information (e.g., pressure measurements, thresholds and offsets) as described herein. This information may be retrieved or otherwise accessed by one or more computing devices, such as computing device 401 or server computing devices 410 in FIG. 4, in order to perform some or all of the features described herein. Storage system 420 may comprise any type of computer storage, such as a hard-drive, memory card, ROM, RAM, DVD, CD-ROM, write-capable, and read-only memories. In addition, storage system 420 may include a distributed storage system where data is stored on a plurality of different storage devices, which may be physically located at the same or different geographic locations (e.g., in a ground station (e.g., 314 in FIGS. 3A-3B), or in a distributed computing system (not shown)). Storage system 420 may be networked to computing device 401 directly using wired connections and/or wireless connections. Such network may include various configurations and protocols, including short range communication protocols such as Bluetooth™, Bluetooth™ LE, the Internet, World Wide Web, intranets, virtual private networks, wide area networks, local networks, private networks using communication protocols proprietary to one or more companies, Ethernet, WiFi and HTTP, and various combinations of the foregoing. Such communication may be facilitated by any device capable of transmitting data to and from other computing devices, such as modems and wireless interfaces.

Computing device 401 also may include a memory 402. Memory 402 may comprise a storage system configured to store a database 414 and an application 416. Application 416 may include instructions which, when executed by a processor 404, cause computing device 401 to perform various steps and/or functions, as described herein. Application 416 further includes instructions for generating a user interface 418 (e.g., graphical user interface (GUI)). Database 414 may store various algorithms and/or data, including neural networks (e.g., encoding flight policies, as described herein) and data regarding wind patterns, weather forecasts, past and present locations of aerial vehicles (e.g., aerial vehicles 120a-b, 201a-b, 211a-c), sensor data, map information, air traffic information, among other types of data. For example, database 414 may store pressure measurements, thresholds, offsets and other information for the FTS, as described herein. Memory 402 may include any non-transitory computer-readable storage medium for storing data and/or software that is executable by processor 404, and/or any other medium which may be used to store information that may be accessed by processor 404 to control the operation of computing device 401.

Computing device 401 may further include a display 406, a network interface 408, an input device 410, and/or an output module 412. Display 406 may be any display device by means of which computing device 401 may output and/or display data. Network interface 408 may be configured to connect to a network using any of the wired and wireless short range communication protocols described above, as well as a cellular data network, a satellite network, free space optical network and/or the Internet. Input device 410 may be a mouse, keyboard, touch screen, voice interface, and/or any or other hand-held controller or device or interface by means of which a user may interact with computing device 401. Output module 412 may be a bus, port, and/or other interface by means of which computing device 401 may connect to and/or output data to other devices and/or peripherals.

In some examples, computing device 401 may be located remote from an aerial vehicle (e.g., remote from aerial vehicles 320a-b, such as in ground station 314, in FIGS. 3A-3B) and may communicate with and/or control the operations of an aerial vehicle, or its control infrastructure as may be housed in avionics chassis 310a-b, via a network. In one embodiment, computing device 401 is a data center or other control facility (e.g., configured to run a distributed computing system as described herein), and may communicate with a controller and/or flight computer housed in avionics chassis 310a-b via a network. As described herein, system 400, and particularly computing device 401, may be used for planning a flight path or course for an aerial vehicle based on wind and weather forecasts to move said aerial vehicle along a desired heading or within a desired radius of a target location. Various configurations of system 400 are envisioned, and various steps and/or functions of the processes described below may be shared among the various devices of system 400, or may be assigned to specific devices.

### Example Methods

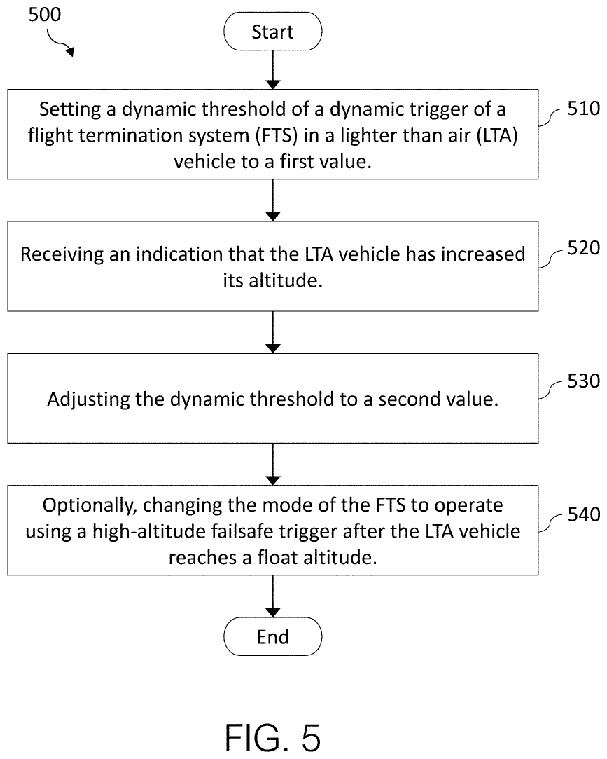

FIG. 5 is a flow diagram illustrating a method 500 for operating an FTS in an LTA vehicle. In step 510, a dynamic threshold of a dynamic trigger of an FTS for an LTA vehicle is set to a first value. In step 520, an indication is received that the LTA vehicle (e.g., vehicles 320a-b in FIGS. 3A-3B) has increased its altitude. In some cases, there is a minimum increase in altitude required in order for the indication to be received that the LTA vehicle has increased its altitude. In step 530, the dynamic threshold is adjusted to a second value. Optionally, in step 540, the mode of the FTS is changed to operate using a high-altitude failsafe trigger rather than a dynamic trigger, for example, in response to the LTA vehicle reaching a float altitude (e.g., when the altitude of the LTA vehicle is above a float altitude floor). In some cases, a computer (e.g., computing system 400 in FIG. 4) controls the FTS to perform the steps of method 500, for example, by setting the dynamic thresholds, and receiving the indication that the LTA vehicle has increased its altitude.

The dynamic thresholds in method 500 can be calculated from absolute pressure or pressure altitude measurements and predetermined offsets (which can be static or dynamic) In some cases, step 510 comprises measuring a first absolute pressure or pressure altitude and applying a predetermined offset (or other transformation) to determine the first value of the dynamic threshold. In some cases, step 530 comprises measuring a second absolute pressure or pressure altitude and applying a predetermined offset (or other transformation) to determine the second value of the dynamic threshold. In some cases, the absolute pressure or pressure altitude are measured using one or more sensors onboard the LTA vehicle. In some cases, a static offset can be added or subtracted from the measured absolute pressure or pressure altitude, respectively, to determine the dynamic thresholds. In other cases, the measured absolute pressure or pressure altitude can be transformed by applying a function or using a lookup table to determine the dynamic thresholds. In some cases, a computer (e.g., computing system 400 in FIG. 4) receives the measurements from the sensors, and calculates the dynamic thresholds (e.g., by applying offsets or other functions, as described herein). In some cases, the dynamic threshold is adjusted continuously as the altitude increases. In some cases, the dynamic threshold changes each time a measurement of an absolute pressure or pressure altitude is received. For example, the measurements could be taken at a frequency of once per second, once per minute, once every hour, from once per second to once every hour, or less than once per hour, and the dynamic threshold can be changed every time a measurement is received. In some cases, there is a predetermined number of times the threshold is adjusted over a predetermined period of time. For example, the threshold can be adjusted 10 times, 100 times, 1000 times, 10,000 times, from 10 to 10,000 times, or more than 10,000 times, over a period of time of 1 hour, 4 hours, 12 hours, 24 hours, from 1 to 24 hours, more than 24 hours, or for a period of time defined by an attribute of the LTA vehicle (e.g., the period of time can be the duration of the initial ascent of the LTA vehicle).

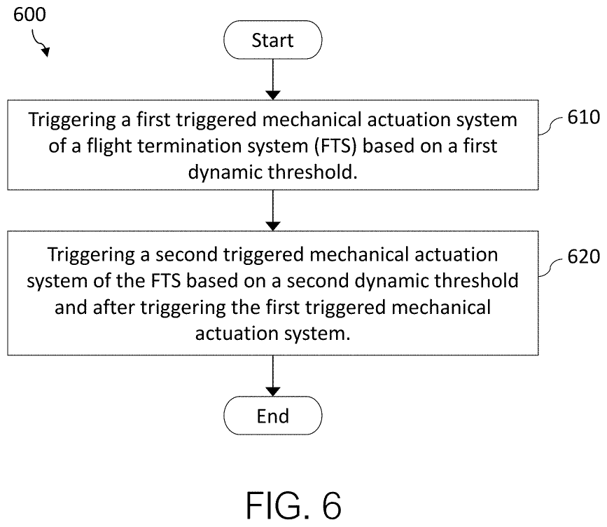

FIG. 6 is a flow diagram illustrating a method 600 for terminating the flight of an LTA vehicle. In step 610, a first triggered mechanical actuation system of an FTS is triggered based on a first dynamic threshold. In some cases, triggering the first triggered mechanical actuation system causes the first triggered mechanical actuation system to fire (e.g., using a squib) and to separate an envelope and a payload of the LTA vehicle. In some cases, step 610 in method 600 is performed after step 510, 520 or 530 in method 500.

In step 620, a second triggered mechanical actuation system of an FTS is triggered based on a second dynamic threshold. In some cases, triggering the second triggered mechanical actuation system causes the second triggered mechanical actuation system to fire and to deploy a parachute from the payload. In some cases, a computer (e.g., computing system 400 in FIG. 4) controls the FTS to perform the steps of method 600, for example, by triggering the first and second triggered mechanical actuation systems based on the dynamic thresholds.

While specific examples have been provided above, it is understood that the present invention can be applied with a wide variety of inputs, thresholds, ranges, and other factors, depending on the application. For example, the time frames and ranges provided above are illustrative, but one of ordinary skill in the art would understand that these time frames and ranges may be varied or even be dynamic and variable, depending on the implementation.

As those skilled in the art will understand, a number of variations may be made in the disclosed embodiments, all without departing from the scope of the invention, which is defined solely by the appended claims. It should be noted that although the features and elements are described in particular combinations, each feature or element can be used alone without other features and elements or in various combinations with or without other features and elements.

What is claimed is:

1. A flight termination system (FTS) for a lighter than air (LTA) vehicle, comprising:
a first mechanical actuation system configured to be triggered in a first stage based on a first dynamic threshold, the first mechanical actuation system further configured to cause an envelope and a payload of the LTA vehicle to separate; and
a second mechanical actuation system configured to be triggered in a second stage based on a second dynamic threshold, the second mechanical actuation system further configured to cause a parachute to deploy from a component coupled to the payload,
wherein the first and second dynamic thresholds change, and
wherein the FTS is configured to trigger the first mechanical actuation system before triggering the second mechanical actuation system.

2. The flight termination system for a lighter than air vehicle of claim 1, wherein the first and second mechanical actuation systems each comprise a squib.

3. The flight termination system for a lighter than air (LTA) vehicle of claim 1, wherein the first dynamic threshold and the second dynamic threshold are each a pressure altitude threshold that is updated during an initial ascent of the LTA vehicle based on a measured pressure altitude minus a predetermined offset.

4. The flight termination system for a lighter than air vehicle (LTA) of claim 1, wherein the first dynamic threshold and the second dynamic threshold are each an absolute pressure threshold that is updated during an initial ascent of the LTA vehicle based on a sum of a measured absolute pressure and a predetermined offset.

5. A method of terminating the flight of a lighter than air (LTA) vehicle, comprising:
triggering a first mechanical actuation system of a flight termination system (FTS) based on a first dynamic threshold, thereby causing the first mechanical actuation system to fire, in response to which an envelope and a payload of the LTA vehicle is separated;
triggering a second triggered mechanical actuation system of the FTS based on a second dynamic threshold and after triggering the first triggered mechanical actuation system, thereby causing the second triggered mechanical actuation system to fire, in response to which a parachute is deployed from the payload,
wherein the first and second dynamic thresholds change.

6. The method of claim 5, wherein the first and second mechanical actuation systems each comprise a squib.

7. The method of claim 5, wherein each of the first dynamic threshold and the second dynamic threshold is an pressure altitude threshold that is updated during an initial ascent of the lighter than air vehicle based on a measured pressure altitude minus a predetermined offset.

8. The method of claim 7, wherein the predetermined offset is constant.

9. The method of claim 7, wherein the predetermined offset is variable and is determined using a function or a lookup table.

10. The method of claim 5, wherein each of the first dynamic threshold and the second dynamic threshold is an absolute pressure threshold that is updated during an initial ascent of the lighter than air vehicle based on a measured absolute pressure plus a predetermined offset.

11. The method of claim 10, wherein the predetermined offset is constant.

12. The method of claim 10, wherein the predetermined offset is variable and is determined using a function or a lookup table.

13. The method of claim 5, further comprising, before triggering the first mechanical actuation system of the flight termination system, performing the following steps:
setting a third dynamic threshold to a first value;
receiving an indication that the altitude of the lighter than air vehicle has increased; and
setting a fourth dynamic threshold to a second value.

14. A method of operating a system of a lighter than air (LTA) vehicle, comprising:
setting a dynamic threshold of a system to a first value based on a first predetermined offset and one or both of a first measured pressure altitude and a first measured absolute pressure;
receiving an indication that the LTA vehicle has increased its altitude; and
setting the dynamic threshold of the system to a second value, in response to the indication that the LTA vehicle has increased its altitude, based on a second predetermined offset and one or both of a second measured pressure altitude and a second measured absolute pressure.

15. The method of claim 14, wherein the first and second absolute pressure measurements and the first and second pressure altitude measurements are measured using one or more sensors onboard the LTA vehicle.

16. The method of claim 14, further comprising, after setting the second dynamic threshold, and after an altitude of the LTA vehicle is above a float altitude floor, changing a mode of the system to operate using a high-altitude failsafe trigger.

17. The method of claim 14, wherein the predetermined offset is constant.

18. The method of claim 14, wherein the predetermined offset is variable and is determined using a function or a lookup table.

19. The method of claim 14, wherein the system is a flight termination system.
